(19) United States
(12) Patent Application Publication
(10) Pub. No.: US 2023/0316844 A1
(43) Pub. Date: Oct. 5, 2023

(54) METHOD OF OPERATING BILL TRANSPORT PATH SWITCHING DEVICE IN ATM

(71) Applicant: Hyosung TNS Inc., Seoul (KR)

(72) Inventors: Hyun Soo JANG, Suwon-si (KR); Yun Su PARK, Seongnam-si (KR); JIn You LIM, Anyang-si (KR); Sung Ho PARK, Seoul (KR); Da Hye SHIN, Incheon (KR); Seung Ki KIM, Seongnam-si (KR); Eui Sun CHOI, Bucheon-si (KR); Hyun Ji JO, Seoul (KR)

(21) Appl. No.: 18/193,239

(22) Filed: Mar. 30, 2023

(30) Foreign Application Priority Data
Apr. 4, 2022 (KR) 10-2022-0041632
Dec. 5, 2022 (KR) 10-2022-0167756

(51) Int. Cl. G07D 11/18; G07D 11/23

(52) U.S. Cl. CPC G07D 11/18; G07D 11/23

(57) ABSTRACT

The present disclosure relates to a method of operating a bill transport path switching device in an automated teller machine (ATM), which increases the transfer speed of bills by narrowing a transfer interval between the bills and improves efficiency of a bill deposit and counting process, in a way to accurately calculate timing at which each bill enters the bill transport path switching device so that the bills are transferred without an error regardless of whether a transparent part is included in the bill even in a situation in which paper bills and polymer bills are transferred together, by controlling switching timing of the bill transport path switching device that is provided in the transport path of bills within an ATM for handling polymer bills based on a sensor signal of a bill detection sensor that is provided in a discrimination part of the ATM.

### CROSS-REFERENCE TO RELATED APPLICATIONS

This application claims priority to Republic of Korea Patent Application No. 10-2022-0041632, filed on Apr. 4, 2022, and Republic of Korea Patent Application No. 10-2022-0167756, filed on Dec. 5, 2022, which are incorporated by reference herein in their entirety.

### TECHNICAL FIELD

The present disclosure relates to a method of operating a bill transport path switching device in an automated teller machine (ATM), and more particularly, to a method of operating a bill transport path switching device in an ATM, which increases the transfer speed of bills by narrowing a transfer interval between the bills and improves efficiency of a bill deposit and counting process, in a way to accurately calculate timing at which each bill enters the bill transport path switching device so that the bills are transferred without an error regardless of whether a transparent part is included in the bill even in a situation in which paper bills and polymer bills are transferred together, by controlling switching timing of the bill transport path switching device that is provided in a transport path of bills within an ATM for handling paper bills and polymer bills based on a sensor signal of a bill detection sensor that is provided in a discrimination part of the ATM.

### BACKGROUND ART

An automatic teller machine (ATM) which is installed at places, such as financial institutions and convenience stores, for financial transactions is configured to keep, in its internal cassette, only a bill that has been determined as a normal bill by discriminating the type of bill, whether the miscalculated number of bills has been transferred, whether a bill has been counterfeited and falsified, and whether a bill has been damaged through a discrimination process of a bill passing through a discrimination part in a process of transferring bills that have been deposited in the deposit and withdrawal part of the ATM.

In a common ATM deposit and counting process, after bills pass through the discrimination part, a normal bill is transferred to the temporary receiving part of the ATM and a defective bill, that is, a bill that has been counterfeited or falsified or damaged, is transferred to the rejection box of the ATM, based on discrimination results of the bills by the discrimination part. In this case, in the process of each bill being transferred to the temporary receiving part or the rejection box based on the discrimination results of the bills, the transport path of the bills is configured to be switched by an operation of a bill transport path switching device that is present in the transport path of the bills.

To this end, as disclosed in Korean Patent No. 10-0935806, in a common ATM, an operation of a bill transport path switching device is performed in response to a sensor signal because an entry detection sensor for detecting that a bill enters the bill transport path switching device is provided in front of the bill transport path switching device.

However, a polymer bill made of a plastic material is recently introduced in each country. In general, such a polymer bill includes a transparent part (or a transparent window) for preventing the counterfeit of the bill on one side of the bill. Accordingly, if the entry of the polymer bill into the bill transport path switching device is detected by an entry detection sensor configured as a conventional photo sensor, an error of a sensor signal, such as that the polymer bill is not accurately recognized due to the influence of the transparent part included in the polymer bill, occurs. Due to an error of timing at which the polymer bill enters the bill transport path switching device, which is calculated based on the sensor signal, an error occurs in a switching operation of the bill transport path switching device. As a result, an error occurs in the transfer of the polymer bill.

Accordingly, in a conventional ATM for handling both a paper bill and a polymer bill, in order to prevent an error of the transfer of a bill, which may occur in a process of transferring a polymer bill, an interval between bills is designed to be relatively widely set. In this case, however, there are problems in that the transfer speed of a polymer bill is reduced compared to the conventional transfer speed of a paper bill due to the wide interval between bills and thus efficiency in the entire bill deposit and counting process of the ATM is degraded.

### SUMMARY

Various embodiments are directed to increasing the transfer speed of bills by narrowing a transfer interval between the bills and improving efficiency of the entire bill deposit and counting process in a way to transfer the bills without an error by preventing the occurrence of an error of an optical sensor signal attributable to a transparent part of a bill and the error in the calculation of timing at which a bill enters a bill transport path switching device, in a way to accurately calculate timing at which a bill enters the bill transport path switching device based on a sensor signal of a bill detection sensor that is provided in a discrimination part and to operate the bill transport path switching device based on the accurately calculated timing, in an ATM for handling polymer bills.

In an embodiment, there is provided a method of operating a bill transport path switching device in an automated teller machine (ATM) in controlling a switching operation of the bill transport path switching device for changing a transport path of a bill in a bill deposit and counting process of the ATM. The method may include calculating timing at which a corresponding bill enters the bill transport path switching device based on a sensor signal that is detected through a bill detection sensor provided in a discrimination part, and changing a transport path of the corresponding bill based on discrimination results of the corresponding bill, which are discriminated by the discrimination part, by controlling an operation of the bill transport path switching device based on the calculated entry timing.

In the method of operating a bill transport path switching device in an ATM according to the present disclosure, transit timing of a bill is recognized based on a sensor signal that is obtained through the bill detection sensor of the discrimination part. Timing at which each bill that is transferred along a transport path enters the bill transport path switching device is calculated based on the recognized transit timing. Accordingly, the processing speed of polymer bills can be increased by effectively narrowing a transfer interval between the polymer bills compared to a conventional technology and efficiency of a deposit and counting process of an ATM can be improved by accurately calculating timing at which each bill that is transferred through the discrimination part enters the bill transport path switching device, regardless of whether a transparent part is present on one side of a polymer bill and a location at which the transparent part is present.

Furthermore, in the method of operating a bill transport path switching device in an ATM according to the present disclosure, skew occurrence information of a bill, which frequently occurs in the discrimination part including various sensors and having a narrow transfer width, is effectively obtained through the bill detection sensor provided in the discrimination part. When timing at which a bill enters the bill transport path switching device is detected and calculated, an operation of the bill transport path switching device is adjusted by incorporating the skew information of the bill. Accordingly, the transport path of the bill can be accurately changed without an error.

### BRIEF DESCRIPTION OF DRAWINGS

FIG. 1 is a diagram for schematically describing a bill deposit and counting process of an ATM.

FIGS. 2A and 2B are diagrams illustrating a gate entry process of a bill that is transferred in a conventional ATM.

FIG. 3 is a block diagram schematically illustrating an arrangement structure of sensors within a discrimination part.

### DETAILED DESCRIPTION

The present disclosure may be changed in various ways and may have various forms. Although specific embodiments of the present disclosure are described in detail below with reference to the accompanying drawings, the present disclosure is not limited to the following embodiments as long as the present disclosure does not deviate from the subject matter of the present disclosure.

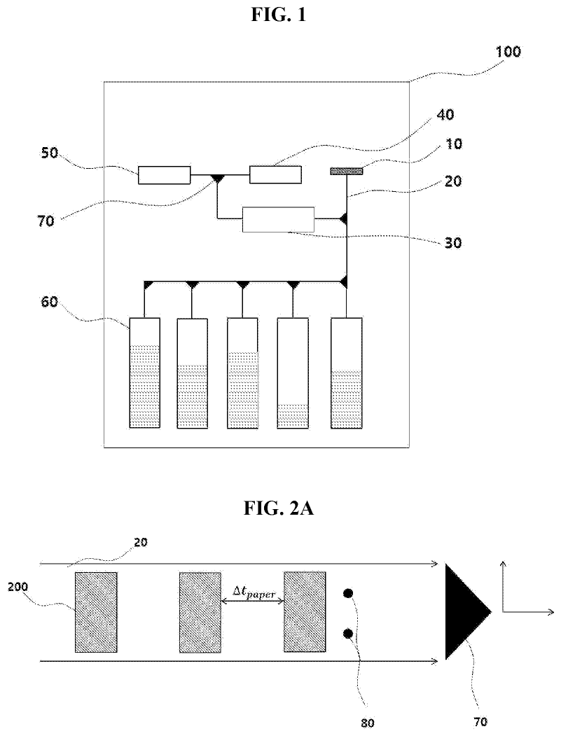

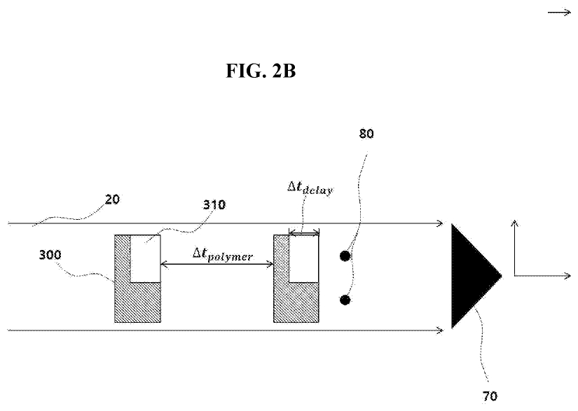

FIG. 1 is a diagram for schematically describing a bill deposit and counting process of an ATM. FIG. 2 is a diagram illustrating a gate entry process of a bill that is transferred in a conventional ATM.

As illustrated in FIG. 1, an ATM 100 includes a deposit and withdrawal part 10 provided for the deposit and withdrawal of a bill, a transport path 20 that operates for the transfer of a bill within the ATM, a discrimination part 30 for discriminating whether a bill has been counterfeited and falsified or whether a bill has been damaged, a rejection box 40 for temporarily keeping a bill that has been determined as a defective bill as a result of the discrimination in order to discharge the defective bill to the outside of the ATM, a temporary receiving part 50 for keeping a bill that has been determined as a normal bill until corresponding transactions are completed, a plurality of bill cassettes 60 for each type in which bills are classified and kept, and a controller (not illustrated) for controlling an operation of each of the aforementioned components and processing information. In this case, a bill transport path switching device 70 for changing a transport path of a bill based on discrimination results of the bill that is transferred is provided at a bill transport path branch point on the transport path 20 along which bills are transferred.

A deposit and counting process of bills is described based on the ARM. First, in a financial transaction process that is performed through the ATM 100, a bill that is deposited through the deposit and withdrawal part 10 is transferred to an internal space of the ATM 100 along the transport path 20.

The bill that is transferred along the transport path 20 as described above experiences a discrimination process of the bill passing through the discrimination part 30. The discrimination part 30 includes various sensors, such as a photo sensor, an image sensor, and a thickness detection sensor, and generates sensor signals for discriminating the type of bill, whether the miscalculated number of bills has been transferred, whether a bill has been counterfeited and falsified, and whether a bill has been damaged. In this case, the generated sensor signals are transferred to the controller.

The controller is configured to derive discrimination results of a bill based on a sensor signal that is received from the discrimination part 30 and to set a transport path of each bill based on the derived discrimination results so that the bill transport path switching device 70 operates, so that the bill is supported to be transferred to the temporary receiving part 50 or the rejection box 40.

In this case, if the bill that passes through the discrimination part 30 in the aforementioned process is determined as a normal bill, the normal bill is transferred to the temporary receiving part 50 along the transport path 20 after passing through the discrimination part 30. If the bill that passes through the discrimination part 30 is determined as a defective bill, the defective bill is transferred to the rejection box 40. In this case, as in FIG. 1, the rejection box 40 may be configured as a separate cassette that is provided on the transport path or may be configured to form a separate rejection receipt space through a partition in the deposit and withdrawal part 10 and to receive the defective bill in the separate rejection receipt space.

When bills are transferred to the temporary receiving part 50 and the rejection box 40, a deposit and counting process is completed. Thereafter, the ATM 100 displays deposit and counting results on a display that is provided outside the ATM. When a user checks the counting results of corresponding financial transactions and then completes the financial transactions, a deposit receipt process of a defective bill kept in the rejection box 40 being transferred back to the deposit and withdrawal part 10 via the discrimination part 30 and then recovered by the user and of a normal bill kept in the temporary receiving part 50 being transferred and kept in the bill cassette 60 for each type via the discrimination part 30 is performed.

As described above, in the deposit and counting and receipt process of a bill that is deposited in the ATM, a transport path of each bill is determined based on discrimination results of the bill. In this case, in the process of the bill being transferred, the bill transport path switching device 70 is formed at a branch point at which the path of a bill is branched, and changes a transport path of a bill that is transferred based on discrimination results of the bill.

Furthermore, in a common ATM, a pair of entry detection sensors consisting of photo sensors is provided in front of the bill transport path switching device 70. Operation timing of the bill transport path switching device is determined based on a sensor signal that is generated by the detection of a bill by the entry detection sensors.

However, at least the least operation time is required for an operation of changing the transport path of a bill by the bill transport path switching device 70. Furthermore, some errors may occur even in calculation results of timing at which the bill enters the bill transport path switching device, which are based on a sensor signal obtained through the entry detection sensor, because a skew phenomenon in which the bill is twisted to one side thereof in the bill transfer process occurs. In order to effectively prevent a bill transfer error occurring in the switching operation of the bill transport path switching device for the transport path of a bill and an operation of the bill transport path switching device due to the calculation error of the timing at which the bill enters the bill transport path switching device, in a common ATM, at least marginal interval is maintained between bills that are transferred along the transport path. This is described in detail below with reference to FIG. 2.

FIG. 2A illustrates a gate entry process of a paper bill. FIG. 2B illustrates a gate entry process of a polymer bill. Referring to FIGS. 2A and 2B, as described above, the bill transport path switching device 70 and the entry detection sensors 80 for calculating timing at which a bill enters the bill transport path switching device 70 are provided on the transport path 20 of the conventional ATM.

As in FIG. 2A, conventional paper bills 200 that are transferred along the transport path 20 are transferred at a given time interval (Δtₚₐₚₑᵣ) by considering the time taken for an operation of the bill transport path switching device 70 and the time for preventing a transfer error which may occur due to the skew of a paper bill.

In contrast, referring to FIG. 2B, in the case of a conventional polymer bill 300, a difference of Δt_{delay}, that is, detection timing delay, occurs at timing at which the polymer bill is detected, which is obtained by each entry detection sensor 80, due to a transparent part 310 provided on one side of the polymer bill.

Accordingly, in the transfer of the common polymer bill 300, the time taken for an operation of the bill transport path switching device 70 and the influence attributable to the occurrence of the skew of the polymer bill need to be considered. Furthermore, the detection timing delay (Δt_{delay}) attributable to the transparent part 310 provided on one side of the polymer bill 300 needs to be considered. Accordingly, in general, Δt_{polymer}, that is, a transfer interval between the polymer bills 300, is inevitably greater than the detection timing delay (Δtₚₐₚₑᵣ). As a result, an interval between the polymer bills 300 that are transferred along the transport path in the ATM for handling the polymer bills 300 needs to be much wider than an interval between the paper bills 200 in the conventional ATM for handling the paper bills 200. Accordingly, the ATM for handling the polymer bills have problems in that the processing speed of polymer bills are relatively low. In particular, the delay of the processing speed of polymer bills, which occurs in a deposit and counting process of the ATM, inevitably causes inconvenience because a customers' waiting time that is taken to use the ATM is increased.

In order to solve such a problem, in the present disclosure, in order to discriminate the type of bill that is transferred along the transport path, whether the miscalculated number of bills has been transferred, and whether a bill has been damaged, an ATM is configured to control an operation of the bill transport path switching device by calculating timing at which each bill enters the bill transport path switching device, based on a sensor signal that is obtained by a thickness detection sensor or a contact image sensor capable of accurately detecting transit timing of a bill regardless of a transparent part included in the bill, among various bill detection sensors provided in the discrimination part. Accordingly, the ATM has been implemented so that bills are transferred by accurately calculating timing at which each bill enters the bill transport path switching device, regardless of whether a bill that passes through the discrimination part along the transport path is a paper bill or a polymer bill or whether a transparent part is included in a bill.

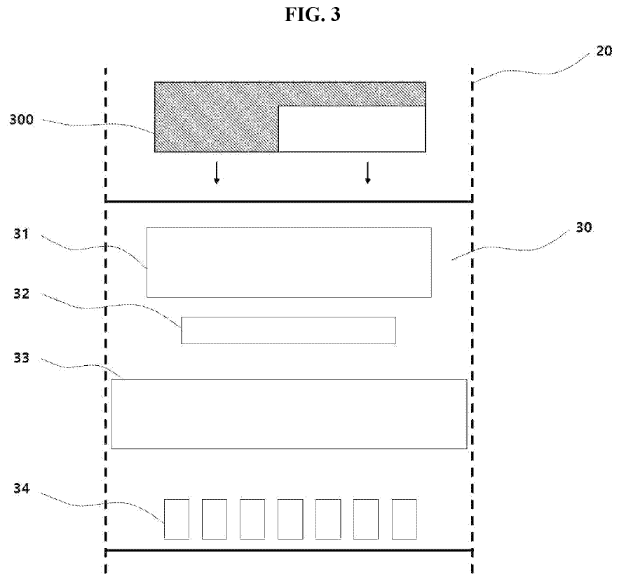

FIG. 3 is a diagram schematically illustrating an arrangement structure of sensors within a discrimination part. As illustrated in FIG. 3, a discrimination part 30 includes various sensors, such as a magnetic sensor 31, a UV sensor 32, a contact image sensor (CIS) 33, and a thickness detection sensor 34, in order to discriminate the type of bill, whether a bill has been counterfeited and falsified, whether a bill has been damaged, the thickness of a bill, and whether the miscalculated number of bills has been transferred. In this case, the thickness detection sensor 34 for detecting the thickness of a bill basically consists of a hall effect sensor or a piezoelectric sensor, and can accurately recognize transit timing of a bill 300, regardless of whether a transparent part is included in the bill, by detecting the thickness of the bill 300 that passes through the discrimination part 30 along a transport path 20. Furthermore, the CIS 33 basically consists of a complementary metal oxide semiconductor (CMOS) image sensor, and can accurately recognize transit timing of a bill, regardless of whether a transparent part is included in the bill, by scanning a front image of the bill that is transferred along the transport path 200.

Accordingly, in the present disclosure, by taking notice of such a point, the ATM is configured to control an operation of a bill transport path switching device based on a sensor signal that is obtained through the thickness detection sensor or the contact image sensor, in a process of a bill that is transferred along the transport path passing through the discrimination part. Transit timing of a bill that passes through the discrimination part is accurately recognized and operation timing of the bill transport path switching device is calculated and controlled based on the recognized transit timing, regardless of whether the bill is a polymer bill or a paper bill and a transparent part is included in the bill. Accordingly, a marginal interval between bills that are transferred along the transport path can be effectively reduced by fundamentally preventing the occurrence of an error in the detection of timing at which each polymer bill enters the bill transport path switching device, which occurs due to a transparent part included in the polymer bill in the conventional ATM. Accordingly, efficiency of a bill deposit and counting process can be improved by increasing the transfer speed of bills.

Furthermore, as illustrated in FIG. 3, in general, the thickness detection sensor 34 and/or the CIS 33 are disposed closely to the rear end of the discrimination part through which bills pass in the transfer direction of the bills that are deposited and counted. Skew occurrence information of a bill, which frequently occurs in the discrimination part including various detection sensors and having a relatively narrow transfer width, is effectively obtained through the thickness detection sensor or the CIS disposed at the rear end of the discrimination part. When operation timing of the bill transport path switching device is calculated, switching operation timing of the bill transport path switching device can be effectively adjusted by accurately incorporating the skew information of the bill based on a sensor signal obtained by the thickness detection sensor or the CIS. In this process, a process of calculating and controlling the operation timing of the bill transport path switching device according to the sensor signal can be properly set based on the specifications and use environment of an ATM to which the present disclosure is applied.

That is, a method of operating a bill transport path switching device according to the present disclosure is configured to control a switching operation of the bill transport path switching device by accurately calculating without an error of timing at which each bill enters the bill transport path switching device based on a sensor signal of the bill detection sensor, which is obtained in a process of a bill that is transferred along the transport path passing through the discrimination part in a deposit and counting process of an ATM. A transfer interval between bills is effectively reduced by accurately predicting timing at which each bill enters the bill transport path switching device, regardless of whether a transparent part is included in a bill and a location of the bill where the transparent part is included. Accordingly, there are advantages in that efficiency of a deposit and counting process of the ATM can be improved by increasing the processing speed of bills and the occurrence of a bill skew within the discrimination part having a relatively high bill skew occurrence probability can be effectively handled.

As described above, the present disclosure provides a method of operating a bill transport path switching device in an ATM, which increases the transfer speed of bills by narrowing a transfer interval between the bills and improves efficiency of a bill deposit and counting process, in a way to accurately calculate timing at which each bill enters the bill transport path switching device so that the bills are transferred without an error regardless of whether a transparent part is included in the bill even in a situation in which paper bills and polymer bills are transferred together, by controlling switching timing of the bill transport path switching device that is provided in the transport path within an ATM for handling polymer bills based on a sensor signal of the bill detection sensor that is provided in the discrimination part, in adjusting the switching timing of the bill transport path switching device in the ATM.

Furthermore, it will be evident to a person having ordinary knowledge in the art to which the present disclosure pertains that the present disclosure described above is not limited by the aforementioned embodiments and the accompanying drawings and that the present disclosure may be substituted, modified, and changed in various ways without departing from the technical spirit of the present disclosure.

What is claimed is:

1. A method of operating a bill transport path switching device in an automated teller machine (ATM), in controlling a switching operation of the bill transport path switching device for changing a transport path of a bill in a bill deposit and counting process of the ATM, the method comprising:
determining timing at which a corresponding bill enters the bill transport path switching device based on a sensor signal that is detected through a bill detection sensor provided in a discrimination part of the ATM, and
changing a transport path of the corresponding bill based on discrimination results of the corresponding bill, which are discriminated by the discrimination part, by controlling an operation of the bill transport path switching device based on the calculated entry timing.

2. The method of claim 1, wherein the bill transport path switching device is installed on the transport path between the discrimination part and a temporary receiving part provided in the ATM.

3. The method of claim 1, wherein the bill detection sensor is a thickness detection sensor.

4. The method of claim 3, wherein the thickness detection sensor comprises a hall effect sensor or a piezoelectric sensor.

5. The method of claim 1, wherein the bill detection sensor is a contact image sensor (CIS).

6. The method of claim 5, wherein the CIS comprises a complementary metal oxide semiconductor (CMOS) image sensor.

7. The method of claim 3, wherein the thickness detection sensor is disposed at a rear end of the discrimination part in a transfer direction of a bill that is deposited and counted.

8. The method of claim 1, wherein the ATM is an ATM in which polymer bills and paper bills are mixed and handled.
